(19) United States
(12) Patent Application Publication
(10) Pub. No.: US 2026/0024841 A1
(43) Pub. Date: Jan. 22, 2026

(54) SYSTEM FOR USING PHASE CHANGE MATERIAL BATTERY IN A HEATING SYSTEM

(71) Applicant: Heat Transfer Equipment Company, Inc., Half Moon Bay, CA (US)

(72) Inventors: Austin AMATO, Montara, CA (US); Bill McCABE, San Francisco, CA (US)

(73) Assignee: Heat Transfer Equipment Company, Inc., Half Moon Bay, CA (US)

(21) Appl. No.: 19/274,481

(22) Filed: Jul. 18, 2025

Related U.S. Application Data
(60) Provisional application No. 63/673,160, filed on Jul. 18, 2024.

(51) Int. Cl. H01M 10/659; H01M 10/42; H01M 10/48; H01M 10/6568

(52) U.S. Cl. CPC H01M 10/659; H01M 10/425; H01M 10/48; H01M 10/6568

(57) ABSTRACT

A system for centralized control of electric elements in Phase Change Material (PCM) batteries. The system can activate the electric resistance elements simultaneously with the Heat Pump Water Heater (HPWH) during times of peak demand when the HPWH cannot charge the batteries fast enough. The system activates the electric resistance elements when weather conditions do not permit operation of the HPWH, particularly in low outside air temperatures or for load shifting events or in tandem with the HPWH for enhanced charging for peak demand events. The system activates the electric resistance elements when the HPWH is in defrost mode. The system activates the electric resistance elements when the HPWH is not operational due to an internal fault.

### CROSS REFERENCE TO RELATED APPLICATIONS

This application claims the benefit of U.S. Provisional Application Ser. No. 63/673,160 titled SYSTEM FOR USING PCM BATTERY filed on Jul. 18, 2024 by Austin Amato, the entire disclosure of which is incorporated herein by reference for any and all purposes.

### TECHNICAL FIELD

This disclosure relates to energy storage and, more particularly, to phase change material (PCM) thermal energy storage skid.

### BACKGROUND

In a decarbonized world, it is necessary to store energy in the form of heat water by the most suitable green source. The method of heating water with electricity also takes exceptionally long times and requires large amounts of preheated water to be stored, similar to a battery. Then as the battery is discharged or depleted throughout the day when the grid is heavily taxed it is not efficient to heat the water. Further, it is imperative to achieve decarbonization in the plumbing/HVAC world through properly controlling the entire system of specially placed equipment. Current known systems are wasteful. Therefore, what is needed is a system for utilization of phase change material (PCM) batteries in a thermal energy storage system using an array of PCM batteries that can be modular and scaled, such that there can be multiple banks piped in series, parallel, or have multiple PCM batteries. Additionally, what is needed is a system and method utilizing PCM batteries of varying size.

### SUMMARY

A system is disclosed for utilization of phase change material (PCM) batteries in a thermal energy storage system, which is an array of PCM batteries, in accordance with the various aspects and embodiments of the invention. The system includes a controller to manage PCM batteries, which may be modular and scaled, such that there can be multiple banks of PCM batteries. The system also includes a machine learning model for automation and predictive control.

### BRIEF DESCRIPTION OF THE DRAWINGS

FIG. 1A shows a piping and instrumentation diagram (P&ID) of a closed-loop hot water heating system having a modular hot water tank embodying the principles of the present disclosure.

FIG. 1B shows a piping and instrumentation diagram of a closed-loop hot water heating system having a modular hot water tank embodying the principles of the present disclosure.

FIG. 2 shows a piping and instrumentation diagram of an open loop hot water heating system having a modular hot water tank embodying the principles of the present disclosure.

FIGS. 3A, 3B, and 3C show modular panels for assembly of the modular hot water tank embodying the principles of the present disclosure.

FIG. 4A shows a top view of a closed-loop hot water heating system embodying the principles of the present disclosure.

FIG. 4B shows a front view of a closed-loop hot water heating system embodying the principles of the present disclosure.

FIG. 4C shows an end view of the heat pump of a closed-loop hot water heating system embodying the principles of the present disclosure.

FIG. 4D shows a rear view of a closed-loop hot water heating system embodying the principles of the present disclosure.

FIG. 4E shows an end view of the hot water tank of a closed-loop hot water heating system embodying the principles of the present disclosure.

FIG. 5 shows a flowchart for operating and controlling a hot water heating system embodying the principles of the present disclosure.

FIG. 6 shows a system in accordance with the various aspects and embodiments of the invention.

FIG. 7 is a perspective view of the system of FIG. 6 in accordance with the various aspects and embodiments of the invention.

FIG. 8 is a back view of the system of FIG. 6 in accordance with the various aspects and embodiments of the invention.

FIG. 9 shows a schematic diagram of a system of FIG. 10 in accordance with the various aspects and embodiments of the invention.

FIG. 10 shows a diagram of a system having a controller and phase change material (PCM) batteries in accordance with the various aspects and embodiments of the invention.

FIG. 11 shows a schematic diagram of heat pump water heater (HPWH) and a mixing station of the system of FIG. 10 in accordance with the various aspects and embodiments of the invention.

FIG. 12 shows a schematic diagram of HPWH and a mixing station of the system of FIG. 10 in accordance with the various aspects and embodiments of the invention.

FIG. 13A shows a front view of the system of FIG. 10 in accordance with some aspects and embodiments of the invention.

FIG. 13B shows a back view of the system of FIG. 13A in accordance with some aspects and embodiments of the invention.

FIG. 14 as shows a mixing station of FIG. 11 and FIG. 12 of the system of FIG. 13A in accordance with some aspects and embodiments of the invention.

### DETAILED DESCRIPTION

To the extent that the terms “including”, “includes,” “having”, “has”, “with”, or variants thereof are used in either the detailed description and the claims, such terms are intended to be inclusive in a similar manner to the term “comprising”. The invention is described in accordance with the aspects and embodiments in the following description with reference to the figures, in which like numbers represent the same or similar elements. Reference throughout this specification to “one embodiment,” “an embodiment,” “principles,” or similar language means that a particular feature, structure, or characteristic described in connection with the various aspects, principles, and embodiments are included in at least one embodiment of the invention. Thus, appearances of the phrases “in one embodiment,” “in an embodiment,” “in certain embodiments,” and similar language throughout this specification refer to the various aspects and embodiments of the invention. It is noted that, as used in this description, the singular forms “a,” “an” and “the” include plural referents, unless the context clearly dictates otherwise.

The described features, structures, or characteristics of the invention may be combined in any suitable manner in accordance with the aspects and one or more embodiments of the invention. In the following description, numerous specific details are recited to provide an understanding of various embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring the aspects of the invention.

The present disclosure describes the control and mechanics of thermal striation within an unpressurized/atmospheric modular hot water storage tank for use in domestic hot water or hydronic heating applications with heat pump water heating equipment or other non-carbon methods for heating water (i.e., solar water heating or electricity conversion.

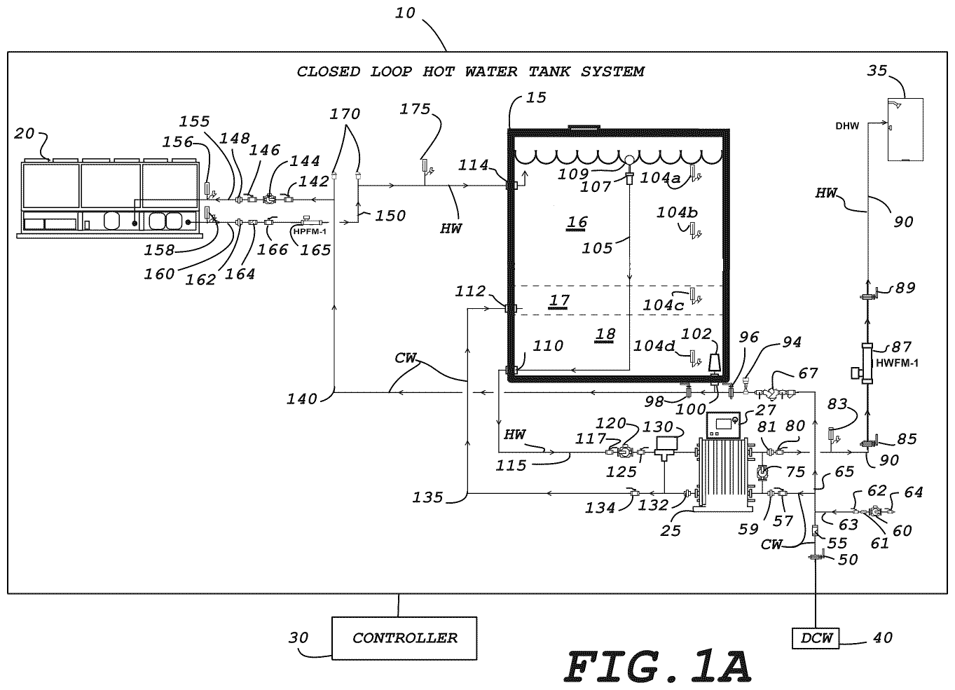

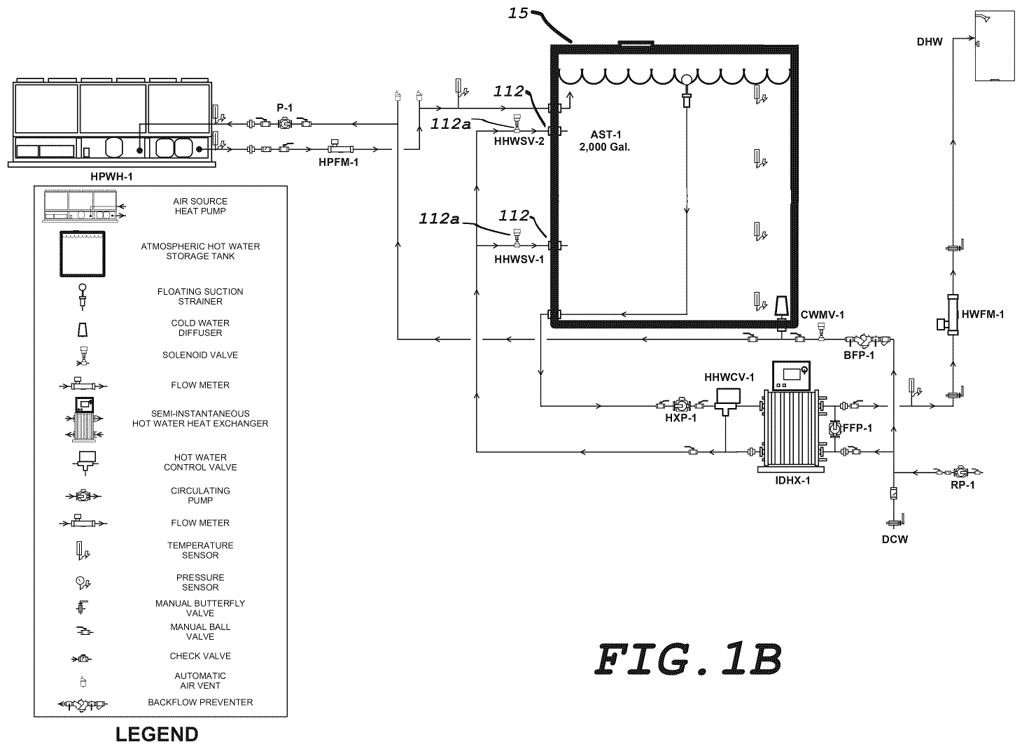

FIG. 1A is a piping and instrumentation diagram (P&ID) of a closed-loop hot water heating system 10 having a modular hot water tank 15 in accordance with an embodiment of the invention. The water tank 15 holds water that is stored in regions 16, 17, 18 that represent different temperature regions and results in temperature striation. The water tank 15 is constructed with non-metallic panels such as fiberglass reinforced plastic molded into panels that are assembled to a desired size and strength for containing a required volume of water. In accordance with other embodiments of the invention, the water tank 15 is constructed from any suitable material. Openings are made in the panels to accept couplings 100, 110, 112, and 114 at chosen locations in the panels on the sides of the unpressurized/atmospheric hot water tank 15 in accordance with an embodiment of the invention.

In accordance with another embodiment of the invention, FIG. 1B shows a P&ID of a closed-loop hot water heating system (similar to the system 10 of FIG. 1A) having more than one coupling 112.

Various embodiments of the invention may include a heat transfer fluid within the closed loop side of the system that contains nanoparticles (nanofluid) which can reduce energy costs, increase thermal conductivity, and increase the capacity of the heat source. In this non-limiting example, there are two couplings 112 shown, each with a solenoid valve 112a to control flow to various parts of the water tank 15 from a controller; the solenoid valve 112a is opened by an electrical signal from a controller 30. As water is redirected back to the water tank 15, each solenoid control valve 112a is controlled by the controller 30. Depending on the redirected water's temperature, one solenoid control valve 112a is selected to control entry of the redirected water (at a specific entry point for the redirected water) back into the water tank 15 in order to maintain the temperature striation in the water tank 15. Accordingly, different temperatures of water will be directed to different locations of the water tank 15 based on the coupling 112 as control by the functioning of the solenoid control valves 112a.

In accordance with some embodiments of the invention, additional couplings 112 and solenoid control values 112a may be added as needed to more precisely control the entry point of the redirected water into the tank based on the temperature gradient of the water in the water tank 15 relative to the temperature of the redirected water back to the water tank 15.

The hot water coupling 114, placed in an upper region of the hot water tank 15, is connected to a hot water pipe 150. The hot water pipe 150 is connected to a heat pump 20 for providing the hot water. The hot water pipe 150 is connected through a flowmeter 165, a manual ball valve 166. and to a union 164. The union 164 couples the hot water pipe 150 to a water pipe section 160. The water pipe section 160 has a temperature sensor 158 attached thereto. The outlet coupling of the heat pump 20 is connected to the section of water pipe section 160. Water from the heat pump 20 flows through the water pipe section 160 and the hot water pipe 150 through the hot water coupling 114 into the upper region 16 of the water tank 15, which has the hottest water (HW) of the water tank 15 in accordance with an embodiment of the invention.

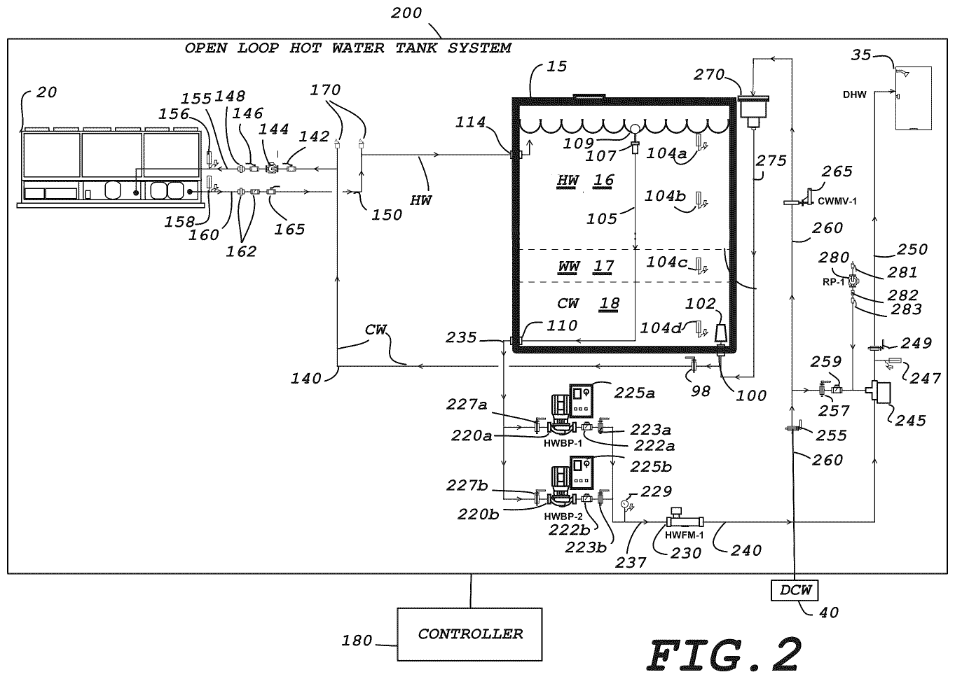

The domestic cold water (DCW) mains 40 is provided by a community, municipal, or private water source (not shown). The cold water is transferred from water mains 40 through a check valve 55 in the water line 65. The check valve 55 prevents water from flowing in a reverse direction to the water mains 40. The cold water is then transferred through a backflow preventer 67 to a cold-water makeup valve 94. The cold-water makeup valve 94 is a solenoid valve that is opened by an electrical signal from a controller 30 when water is required in the water tank 15 due to evaporative loss and drop in water level in the water tank 15. If the water makeup valve 94 is closed, the level within the water tank 15 is good or at the desired level. The water flowing through the manual ball valve 98 is pulling the coldest water at the bottom of the water tank 15 to the heat pumps to ensure optimal efficiency for the heat pumps. The controller 30 receives a signal from a level sensor within the water tank 15 to indicate that the water level has dropped. The controller 30 signals the water makeup valve 94 to allow water to flow through a manual ball valve 96 that manually controls the cold-water flow in accordance with an embodiment of the invention. In accordance with the various embodiments of the invention, “manual ball valves” are also referred to as isolation valves. The manual ball or isolation valves are always open. They are only shut or closed when a piece of equipment must be isolated from the rest of the system for maintenance or replacement. As such, when a reference is made to a value being “open,” it is understood that the valve remain open for the duration of operation and at all times for the operation of the system. When there is a need to close the valve, it is for the purpose of maintenance, repair, or service of equipment. Additionally, an isolation butterfly valve is also an isolation valve that is electrically actuate, for example as noted below with respect to makeup water valve 265 of FIG. 2. Water flows to a coupling 100 placed on a lower wall or bottom of the water tank 15. The water flows into a diffuser 102 to force the water flow to flow downward and have its pressure reduced. The cold water occupies the lower cold-water region 18 of the water tank 15.

A portion of the cold water being fed into the system from the municipal waterworks through pipe 65 flows through the ball valve 57 when the ball valve is open 57. The cold water then flows through the coupling 59 to a first input coupling of the heat exchanger 25 in accordance with an embodiment of the invention. Any hot water being circulated through the heat exchanger 25 provides some heat to the cold water in the heat exchanger 25. The tempered cold-water flows from the heat exchanger 25 through the coupling 132 to tempered cold water line 135. The tempered cold-water line 135 is connected to the coupling 112 of the water tank 15, and the tempered cold water flows through the coupling 112 and into tempered hot water area 17, which is a region between the hot water 16 and the cold water 18 within the water tank 15.

The portion of the water not entering the hot water tank 15 proceeds to the manual ball valve 98 in accordance with an embodiment of the invention. If the cold-water makeup valve 94 is closed, the level within the water tank 15 is good. The water flowing through manual ball valve 98 is pulling the coldest water at the bottom of the tank to the heat pumps to ensure optimal efficiency for the heat pumps.

When the manual butterfly valve 98 is opened, the water flows into the water pipe 140 to the manual ball valve 142. When the manual ball valve 142 opens, the water flows to the circulating pump 144 to the manual ball valve 146. When the manual ball valve 146 opens, the water flows to a union 148. The union 148 couples the cold-water pipe 140 to a water pipe section 155. The water pipe section 155 has a temperature sensor 156 attached to it. The inlet coupling of the heat pump 20 is connected to the section of water pipe 155. The cold water from the water pipe section 155 passes into the heat pump 20 to be heated before being passed to the outlet coupling of the heat pump 20.

In accordance with various embodiments of the invention, the cold-water line 140 and the hot water line 150 are connected to automatic air traps 170 to purge air bubbles from the hot and cold water.

The hot water flows from the hot water region 16 through a suction strainer 107 in accordance with an embodiment of the invention. The suction strainer 107 floats freely within the hot water region 16 by being attached to the float 109. The suction strainer 107 is further attached to a flexible hose 105. The flexible hose 105 connects the suction strainer 107 and a coupling 110. The coupling 110 is connected to the hot water line 115. The hot water line 115 is connected to a manual ball valve 117.

The circulating pump 120 moves the hot water through a manual ball valve 125 to a hot water control valve 130. The hot water control valve 130 further receives cold water from the cold-water line 135 to be mixed with the hot water to cool the hot water to approach the required temperature for domestic hot water in accordance with an embodiment of the invention. The tempered hot water is transferred to an inlet coupling of the hot water heat exchanger 25. The hot water is further tempered by the cold water traveling through the heat exchanger 25. The hot water is discharged from the heat exchanger 25 through a hot water outlet coupling to the coupling 81 to the manual ball valve 80. The hot water then flows to the hot water line 90. The hot water line 90 is connected to temperature sensor 83 and a manual butterfly valve 85. When a manual butterfly valve 85 is open, the hot water flows through the flowmeter 87 and then to a manual butterfly valve 89 to the hot water 90. The hot water line 90 is connected to the fixtures of the user's hot water system. The hot water flows through the hot water line to the fixture of the user's hot water plumbing system 35.

A feedforward pump 75 connects the cold-water inlet line 65 and the hot water outlet line 90. If there is no demand for heat in the heat exchanger 25, the feedforward pump 75 circulates the cold water into the user's plumbing system 35. The heat exchanger includes the feedforward pump 75. If there is a draw in the user's plumbing system 35, then water is sent through the heat exchanger. The feedforward pump 75 is there to facilitate recirculating water movement during time of no demand. The recirculating pump 60 is connected through the manual ball valve 64 to the user's plumbing system 35. The outlet of the recirculating pump 60 is connected through a check valve 61 and the manual ball valve 62 to the water line 63 that feeds into the cold-water line 65. The recirculating pump 60, when activated, brings water from the user's plumbing system 35 and pushes the water into the hot water heating system for reheating.

The heat exchanger 25 has a controller 30 connected to control the flow of the hot water from the water tank 15 and the cold water from the water mains 40. As the cold water passes through the heat exchanger 25 and is sent out to the system, the water makeup valve 94 will remain closed, unless the level of water in the water tank 15 is not sufficient. On the closed loop side of the heat exchanger 25, water flows from the water tank 15 and back to the water tank 15 after it hands off the heat to the cold water going to the system. As noted herein and in accordance with some embodiment of the invention because the water returns back to the water tank 15, more than one coupling 112 exists. Not all of the heat may have been passed off through the heat exchanger 25 depending on the draw, so it is important to place the water back into the water tank 15 at varying levels depending on what corresponding temperatures there are in the water tank 15. The hot water 16 from the water tank 15 will be cooled to a selected temperature for use in the user's plumbing system 35. The controller 30 communicates with temperature sensors within the heat exchanger 25 and communicates with solenoid valves in the heat exchanger 25 to control the flow of the hot water and cold water with the heat exchanger 25.

FIG. 2 is a P&ID of an open loop hot water heating system 200 having a modular hot water tank 15 in accordance with an embodiment of the invention. The water tank 15 and the heat pump 20 are identical to the water tank 15 and heat pump 20 of FIG. 1A and FIG. 1B. The water tank 15 of FIG. 1A and FIG. 1B has a coupling 112 coupled to the water line 135. In FIG. 2, the coupling 112 is omitted from the water tank 15.

As noted above, the domestic cold-water (DCW) is provided by a community, municipal, or private water source (not shown). In this embodiment, the cold water is transferred from water mains 40 through cold water pipe 260 to a manual butterfly valve 255. A portion of the cold-water flows in the cold-water pipe 260 to the electronic makeup water valve 265 in accordance with an embodiment of the invention. When there is a demand for cold water to be added to the water tank 15, the electronic makeup water valve 265 is activated by the flowmeter 230. The flowmeter sends a signal to controller 180; the controller relays the amount of water that must be made up through the makeup water valve 265. The amount of water that flows through flowmeter 230 determines how much water needs to flow through the makeup water valve 265 and the cold-water flows to the adapter coupling 270 attached to the standpipe 275 and the standpipe 275. The opposite end of the standpipe 275 from the standpipe adapter 270 leads to the coupling 100 at the bottom of the water tank 15. The cold-water flows into the diffuser 102 to force the water flow to flow downward and have its pressure reduced and prevent it from flowing out of the lower cold-water region 18 of the water tank 15.

The cold water from standpipe 275 flows to a manual butterfly valve 98. The cold water then flows in the piping 140 to the manual ball valve 142 and then to the circulating pump 144. The flow continues as described above to the cold-water inlet of the heat pump 20. The heat pump 20 functions as described in FIG. 1A and FIG. 1B. The output of the heat pump 20 flows in the hot water pipe 150 to the coupling 114 into the hot water region 16 of the water tank 15.

The hot water flows from the hot water region 16 through a suction strainer 107. The suction strainer 107 floats freely within the hot water region 16 by being attached to the float 109. The suction strainer 107 is further attached to a flexible hose 105. The flexible hose 105 is connected between the suction strainer 107 and a coupling 110, as described above and shown in FIG. 1A and FIG. 1B. In the embodiment of FIG. 2, the coupling 110 is connected to the hot water line 235. The hot water line 235 is divided to enter the two manual butterfly valves 227a and 227b in accordance with an embodiment of the invention. The two manual butterfly valves 227a and 227b are respectively connected to the input couplings of the two booster pumps 220a and 220b with a variable frequency drive (VFD) 225a and 225b. The booster pumps 220a and 220b create the suction required to extract the hot water 16 from the water tank 15. When hot water is in demand by the fixture of a user's hot water plumbing system 35, the booster pumps are activated. The variable frequency drive regulates a constant pressure of the two booster pumps with a variable frequency drive (VFD) 225a and 225b. The VFD includes a primary electrical circuit converting the alternating current (AC) into a direct current (DC), then converting it back into an alternating current (AC) with the required frequency setting the pump pressure to a constant value in accordance with an embodiment of the invention.

The outlet coupling of the two booster pumps with VFDs 225a and 225b are connected respectively to the check valves 222a and 222b. The outlet of the check valves 222a and 222b are connected respectively to the inputs of the two manual butterfly valves 223a and 223b. From outlets of the manual butterfly valves 223a and 223b, the hot water flows into pipes that are joined together to form a single pipe 237 connected to the input coupling of the hot water flowmeter 230. The output of the flowmeter feeds into the hot water pipe 240. The input to the flowmeter has a pressure sensor 229 connected to the hot water pipe 237 for sensing the pressure of the hot water flowing into the flowmeter 230. The flowmeter 230 sends a signal to the controller 180, which s ends a signal to the makeup water valve 265 to make up the amount of water that just flowed through it.

The hot water in the hot water pipe 240 flows to the domestic hot water mixing valve 245 to be mixed with the cold water from the cold-water pipe 260 through the manual butterfly valve 257 and through the check valve 259. In accordance with some embodiments of the invention, the controller 180 can communicate with mixing valve 245. The mixing valve 245 has a setpoint it must achieve, which is dictated to it by the controller 180 and temperature sensors on the inlets compute the required ratio that is communicated to the mixing valve 245. Thus, the temperature sensor reads the temperature of the tempered hot water, transmits the data to the controller 180, and the controller 180 signals or commands the mixing valve 265 to vary the amount of cold and hot water. From check valve 259, the cold-water flows to the domestic hot water mixing valve 245. Further, domestic cold water is recirculated from the user's plumbing system 35 to the recirculating pump 280 and to the domestic hot water mixing valve 245. The cold water, the recirculated cold water, and the hot water are appropriately mixed to the required temperature for domestic hot water.

The tempered hot water flows from the domestic hot water mixing valve 245 into the user's plumbing hot water piping 260. A temperature sensor 247 is attached to the user's plumbing hot water piping 260 for measuring the temperature of the tempered hot water. The temperature data is transmitted to the controller 180, and the controller 180 commands the domestic hot water mixing valve 245 to adjust the hot and cold water mixture appropriately. The tempered hot water flows to the manual butterfly valve 249 and then to the user's plumbing hot water pipe 250 for distribution.

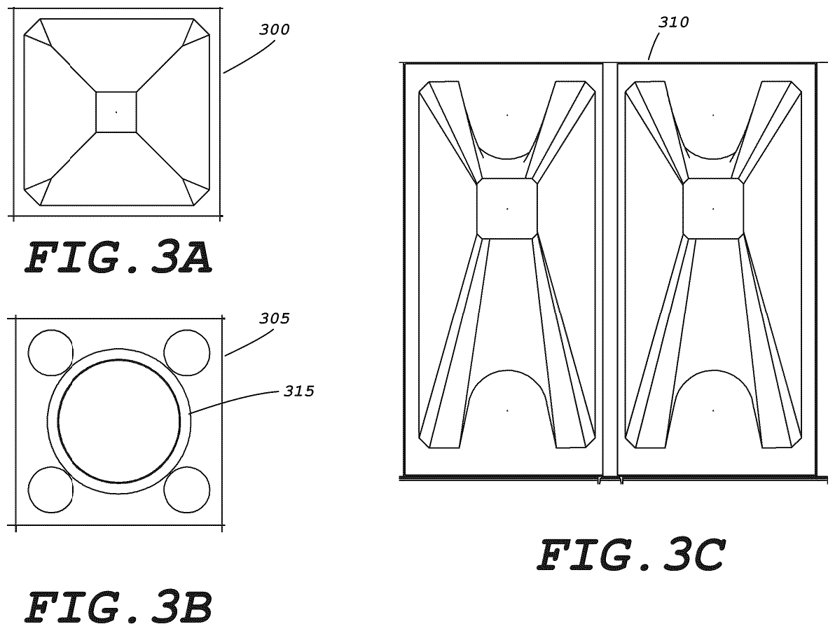

Refer now to FIGS. 3A, 3B, and 3C, drawings of the modular panels for assembly of the modular hot water tank 15 is shown in accordance with an embodiment of the invention. In FIGS. 3A, 3B, and 3C, the panels 300, 305, and 310 are formed of insulated fiberglass reinforced plastic that is molded to the desired thickness. The panels 300, 305, and 310 are formed by pressing a sheet molding compound with a combination of unsaturated polyester and fiberglass roving that is shaped in a mold to form the fiberglass reinforced plastic (FRP) panels 300, 305, and 310 in accordance with an embodiment of the invention. A heat-insulating material is attached to FRP panels to form composite panels.

A maintenance hole panel 300 is an FRP panel having an opening lid 315 in its center. For sanitary reasons, the maintenance hole lid 315 opening has a required rise from the roof panel surface to prevent water and other contaminants from getting inside the water tank 15 in accordance with an embodiment of the invention. The water tank 15 is sealed by a gasket between the lid 315 and the opening. The detachable maintenance hole lid 315 is attached with hinges.

The panels 300, 305, and 310 have an external reinforcement box-frame structure with a sidewall reinforcement, steel footing, and ceiling reinforcement. An internal reinforcement is accomplished at the intersections of the opposing sidewall panels pulled together with stainless sag rods. There are gaskets placed between each panel to meet leaching standards.

Additional insulation of panels 300, 305, and 310 is accomplished by applying additional coats of polystyrene foam to a well-insulated fiberglass reinforced plastic (FRP) panel and covering it with a synthetic resin in accordance with an embodiment of the invention.

While this disclosure has been particularly shown and described with reference to the preferred embodiments thereof, it will be understood by those skilled in the art that various changes in form and details may be made without departing from the spirit and scope of the disclosure.

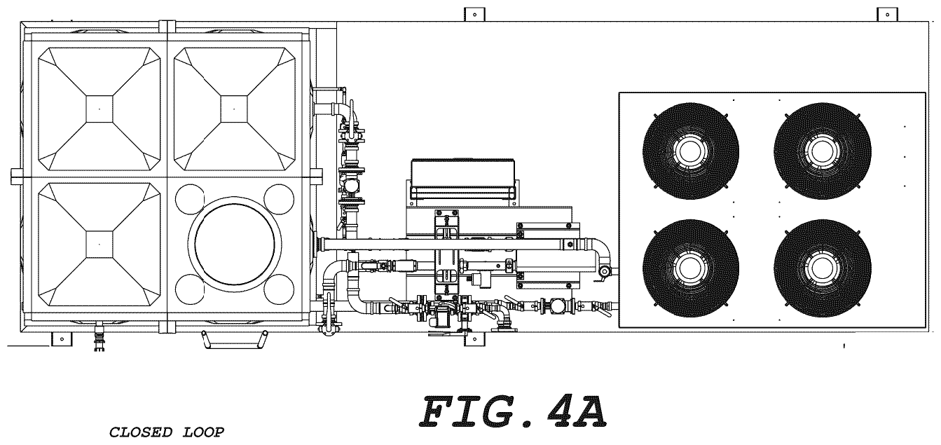

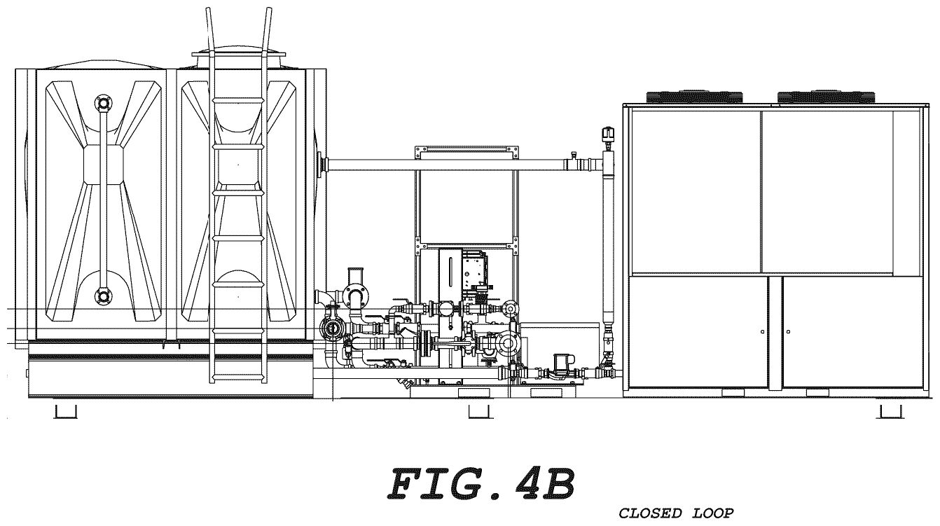

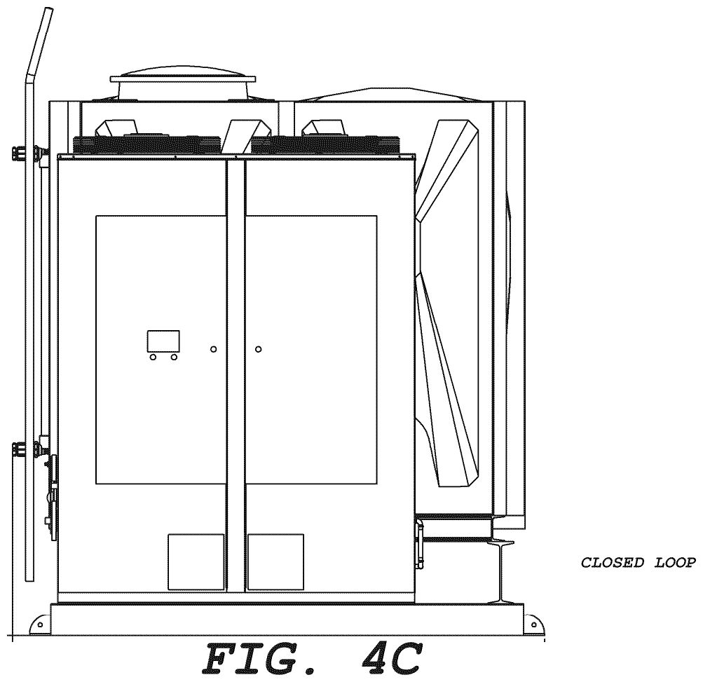

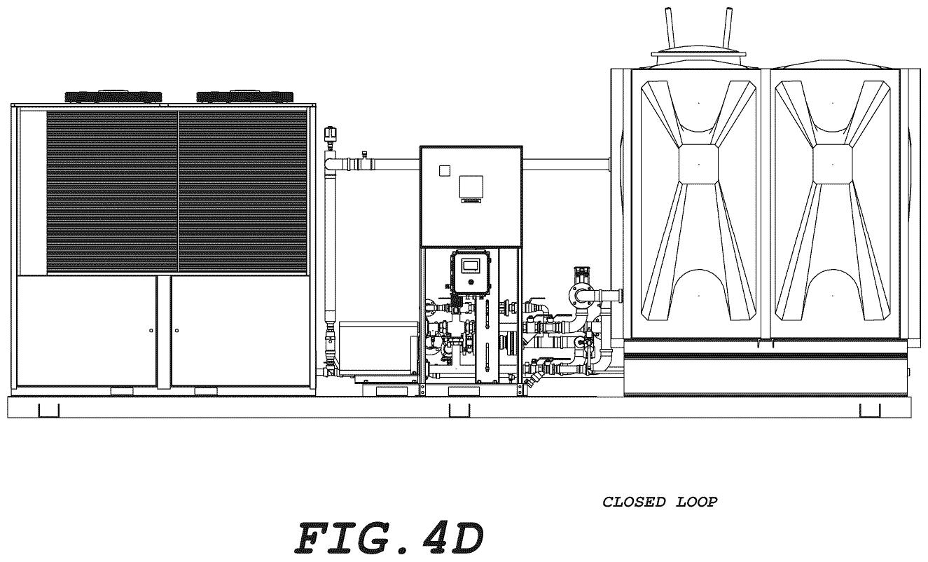

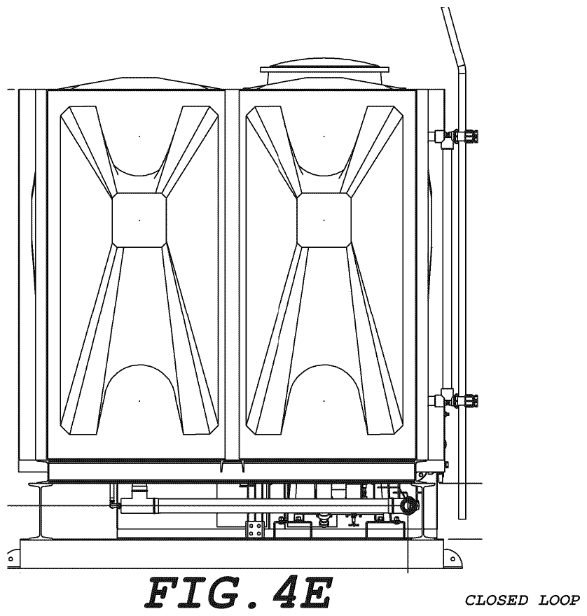

Referring now to FIG. 4A, a top view of a closed-loop hot water heating system is shown in accordance with an embodiment of the invention.

Referring now to FIG. 4B, a front view of a closed-loop hot water heating system is shown in accordance with an embodiment of the invention.

Referring now to FIG. 4C, an end view of the heat pump of a closed-loop hot water heating system is shown in accordance with an embodiment of the invention.

Referring now to FIG. 4D, a rear view of a closed-loop hot water heating system is shown in accordance with an embodiment of the invention.

Referring now to FIG. 4E shows an end view of the hot water tank of a closed-loop hot water heating system which is shown in accordance with an embodiment of the invention.

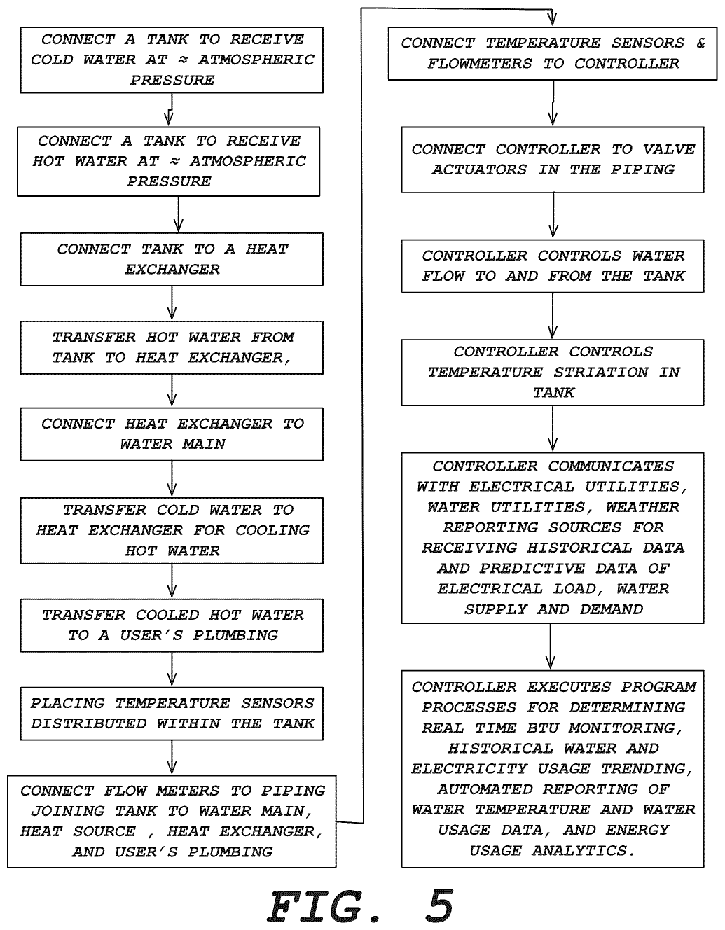

Referring now to FIG. 5, a process is shown for operating and controlling a hot water heating system in accordance with an embodiment of the invention. The process includes connecting a tank to receive cold water and hot water. The process includes connecting the tank to a heat exchanger that heats the water. In accordance with various aspects and embodiments of the invention, the process includes connecting temperature sensors and flowmeters to a controller, wherein the controller communicates with various external sources to receive historical data and predictive data related to electrical demands. In accordance with various aspects and embodiments of the invention, the controller executes programs to determine usage demands and costs based on historical data and predictive data collected in order to control timing of energy demands for the system that is aligned with best usage rates for utilities.

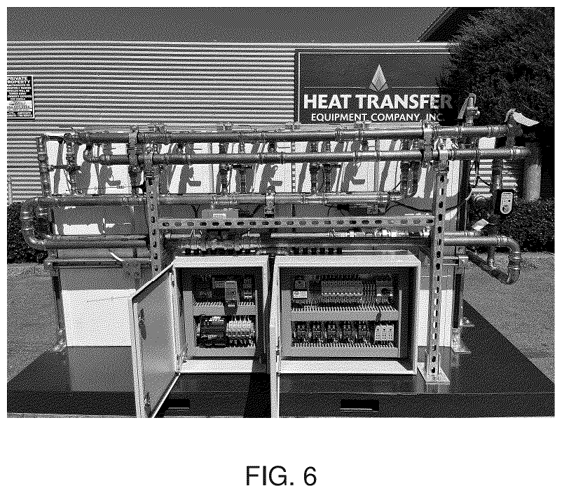

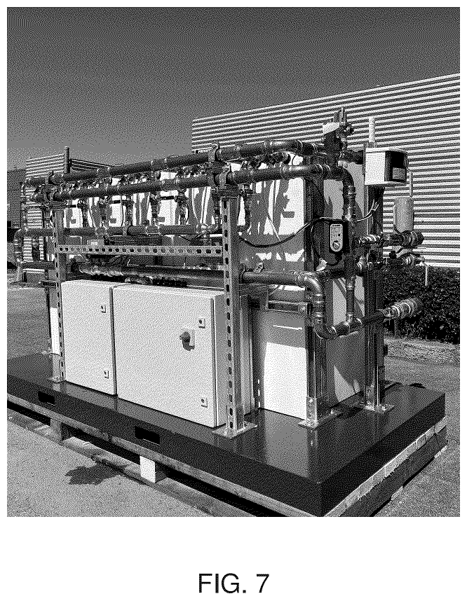

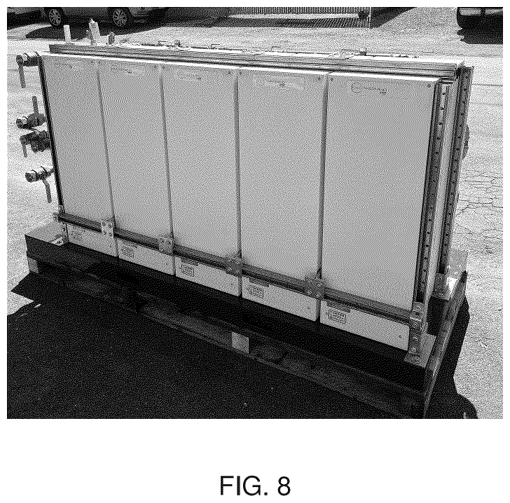

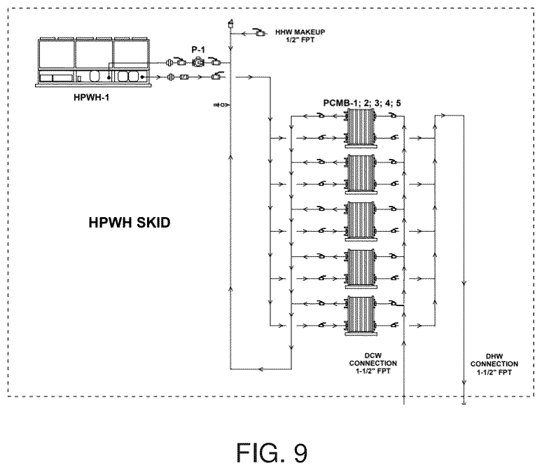

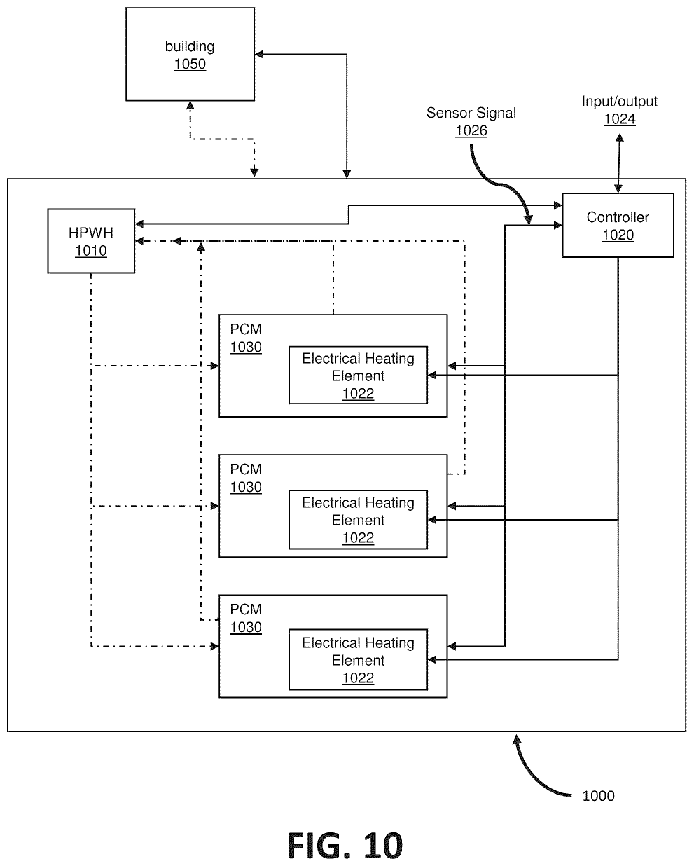

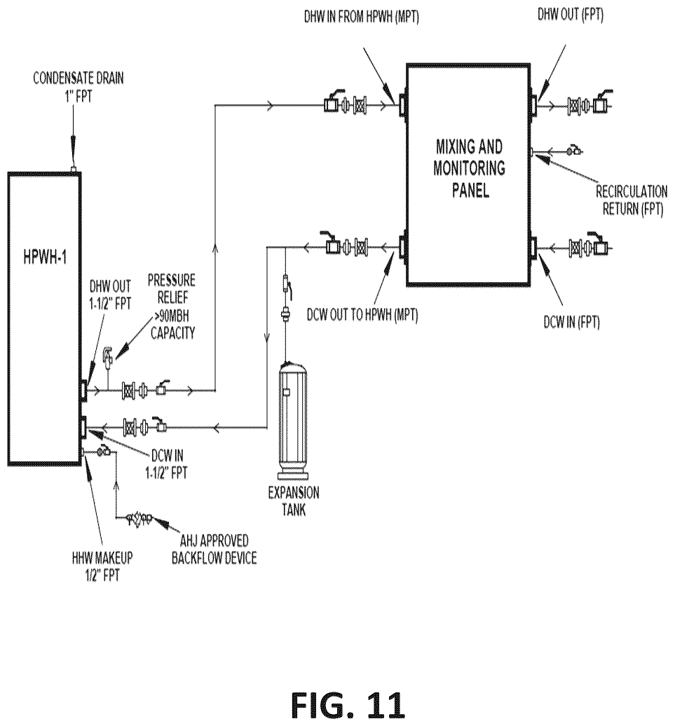

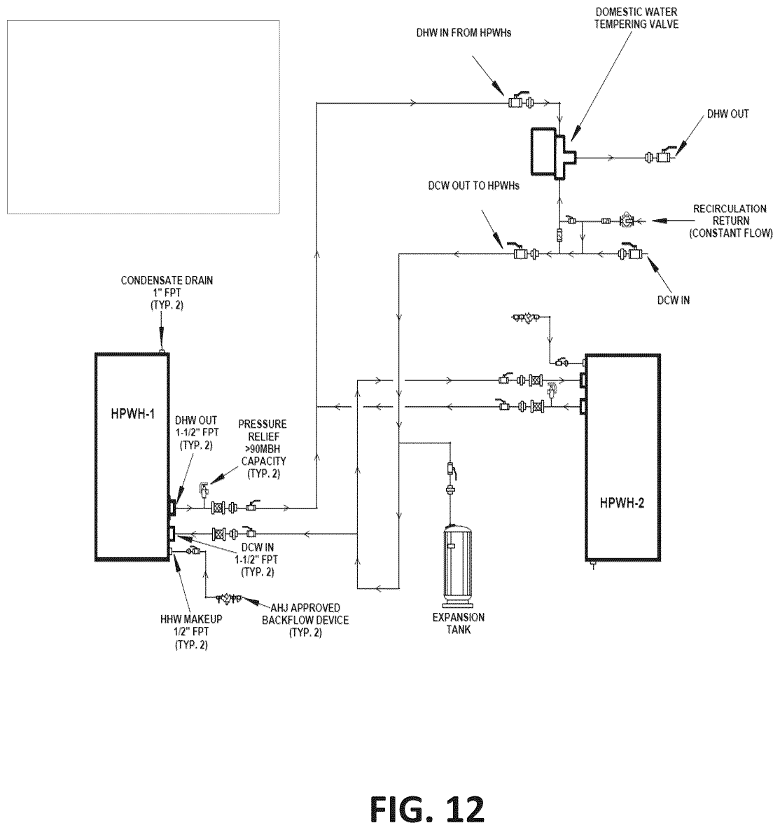

Referring now to FIG. 6, FIG. 7, FIG. 8, FIG. 9, FIG. 10, FIG. 11 and FIG. 12, a system using phase change material (PCM) batteries is shown in accordance with the various aspects and embodiments of the invention. In accordance with various aspects and embodiments of the invention, PCM batteries can include materials such as, but not limited to, sodium acetate trihydrate, which is non-toxic, non-flammable, recyclable, and salt like composition. The PCM batteries have many charge and discharge cycles, which ranges from 40,00 to 80,000 cycles. In accordance with various aspects and embodiments of the invention, a PCM battery has a heat exchanger submerged in the material for charging and discharging. In general, the PCM batteries are more efficient and 4 times (4×) more energy dense than water. The PCM batteries can be put through a heat exchange cycle through heat transfer between the PCM and a pipe containing fluid/liquid or through electrical elements, each of which are positioned throughout or contained within the PCM batteries

Referring now to FIG. 10, a system 1000 is shown with a controller 1020 in accordance with various aspects and embodiments of the invention. The solid lines connecting elements represent flow of electrical current/signals and the broken lines connecting elements represent flow of liquids/fluids (through physical pipes) between indicated end points. The system 1000 includes a Heat Pump Water Heater (HPWH) 1010, a controller 1020 having multiple input and output channels of communication, and PCM batteries 1030, wherein the PCM batteries have overheat protection sensors. Although there are only three PCM batteries shown, the scope of the present invention is not limited by the number of PCM batteries shown as the entire system is scalable.

The controller 1020 is in communication with the electrical heating elements or electrical resistance elements (EHE) 1022 that acts as another or secondary source of heating for the PCM batteries 1030 and wherein the EHE 1022. In accordance with some aspects and embodiments of the invention, the controller collects data about the EHE 1022 for analytics and historical trending of the performance of the EHE 1022 and training data for a machine learning model of the controller 1020. The controller 1020 is in communication with the PCM batteries 1030 and in communication with the HPWH 1010. Further, the controller 1020 is in communication with and can access any wireless network and send/receive data at the output/input 1024, via hard wire and wireless means. In accordance with some aspects and embodiments of the invention, the controller 1020 controls the EHE 1022 through a relay (not shown). In accordance with some aspects and embodiments of the invention, the controller 1020 acts as the relay and sends a high voltage control signal to the EHE 1022 to activate the hearing function of the EHE 1022.

In accordance with some aspects and embodiments of the invention, the controller 1020 sends a low voltage/current signal to a relay, which resides between the controller 1020 and the EHE 1022, and the relay received the low voltage/current signal and switches on the EHE 1022 powered by high voltage/current supply. In accordance with some aspects and embodiments of the invention, the controller 1020 sends similar signals to relays for the HPWH 1010 to control valves through either using a relay or acting as the relay with a direct high voltage signal to the valves.

In accordance with some aspects and embodiments of the invention, the controller 1020 is in communication with the PCM batteries 1030. The PCM batteries 1030 includes sensor circuits (not shown) that generate and send sensor signal or information or feedback to the controller 1020 along signal path 1026. The information includes at least temperature state of the PCM batteries 1030 and if the PCM batteries 1030 need maintenance or repair. In accordance with some aspects and embodiments of the invention, each PCM battery 1030 is detachable and serviceable from the system 1000 without having to shut down operation of the system 1000. Thus the system 1000 can continue to operate while any one or more PCM batteries 1030 are being serviced or repaired and thereby avoiding interfering with the function of the system 1000 in controlling the environment of a building or space 1050. In accordance with some aspects and embodiments of the invention, the controller 1020 is in communication with a building control system (not shown) of the building 1050. As such, the controller can received information or data from the building control system and send data and information to the building control system. The information from the building can be further used to enhance and train the machine learning model of the controller 1020 as discussed herein. In accordance with some aspects and embodiments of the invention, the hot water demand of the building 1050. Each PCM battery 1030 is connected to the system 1000 through detachable fluid (valves) and signal connection points that allow isolation of the specific PCM battery 1030 from the rest of the system 1000.

In accordance with some aspects and embodiments of the invention, the information is sent via a physical communication line. In accordance with some aspects and embodiments of the invention, the information is sent via wireless communication, including one or more of WiFi and Bluetooth.

In accordance with some aspects and embodiments of the invention, the controller 1020 receives data input from various sources. The data or information can originate from various sources, including utility companies, which provide data about rates and ask that HVAC and plumbing equipment be grid-interactive and able to receive signals that shift power consumption/resource consumption and operation to the most advantageous times, which is known as load shifting and demand response.

In accordance with some aspects and embodiments of the invention, the controller 1020 includes artificial intelligence (AI) module, which is implemented by using machine learning models or large language models that are trained using data and further training using feedback. The AI module or unit can control the system based on the trained model's observations of data. In accordance with some aspects and embodiments of the invention, the AI module gets information through at least one or more of the input 1024 (optional), from the building control system of the building 1050, the HPWH 1010, and the PCM batteries 1030 sensor related information sent to the controller 1020, receive data and information about one or more of: environmental conditions, outdoor-air temperature, PCM batteries internal temperatures; time of day; utility demand-response commands and real-time electricity prices; building water usage derived through observing variances of 1030 and 1010 or external inputs from 1024 (such as external flow meters not depicted and optional) and timing of usage. This paragraph is super important but reads a little difficult.

In accordance with some aspects and embodiments of the invention, after learning the building's hot-water usage pattern (for example, time of day vs. PCM temperatures), the AI optimizes the controller's strategy and signal generation. As noted herein, the controller determines when and how much input is provided to the PCM batteries between the HPWH 1010 and the EHE 1022. For example, the AI module can: select heat-source and signal the controller to choose when to run the HPWH 1010 (heat pump) alone and when to supplement the HPWH 1010 with EHE 1022 using electric-resistive elements.

In accordance with some aspects and embodiments of the invention, the AI module can perform predictive charging, where the AI module uses weather forecasts, price signals, and HPWH 1010 past performance curves to pre-heat (charge) the PCM batteries when electricity is cheapest and grid-friendly, ensuring stored thermal energy is ready for peak-demand periods.

In accordance with some aspects and embodiments of the invention, the AI module can control and with continuous adaptation, wherein the controller 1020 is instructed based on refined training data provided as feedback to the AI module as building demand, tariffs, and utility signals evolve. The continuous feedback for training of the performance and improvement of the AI module provides the advantage of reliable hot-water delivery, lower operating costs for the end user, and a system that actively supports grid stability.

In accordance with some aspects and embodiments of the invention, the controller can sends emails and text message alerts to the end user and any third party in the event the system 1000 is in alarm or experiencing an issue. Additionally, the AI module can also predict potential problem with the system 1000 based on training and feedback when the AI module detects or notices odd readings and patterns that are not detectable as a problem in an isolated signal by the system 1000 parameters.

In accordance with some aspects and embodiments of the invention, the system 1000 may be provided as a skid that includes the PCM batteries and the controller and the HPWH in a single unit. The system includes the ability to activate the electric resistance elements simultaneously with the HPWH during times of peak demand when the HPWH cannot charge the PCM batteries fast enough. The system includes the ability to activate the electric resistance elements when weather conditions do not permit operation of the HPWH, particularly in low outside air temperatures. The system includes activation of the electric resistance elements when the HPWH is in defrost mode and the electric resistance elements when the HPWH is not operational due to an internal fault. In accordance with the various aspects and embodiments of the invention, the system includes centralized monitoring of internal temperatures in PCM batteries. The system includes temperature sensors that are located at various positions within each battery, including low, middle, and top regions, to provide comprehensive temperature data. In accordance with the various aspects and embodiments of the invention, the system includes centralized control for heat requests from HPWH(s) utilizing a centralized point of control for each PCM battery to request heat from one or more HPWH units.

In accordance with the various aspects and embodiments of the invention, the system includes standardized multipurpose service valves on PCM batteries, wherein the PCM batteries are equipped with standardized inlets and outlets. More specifically and in accordance with the various aspects and embodiments of the invention, each PCM battery includes two inlets and two outlets, upon which multipurpose service valves are installed, having a union, hose bib, and isolation valves thereby allowing each PCM battery to be isolated, serviced, or replaced without any system downtime.

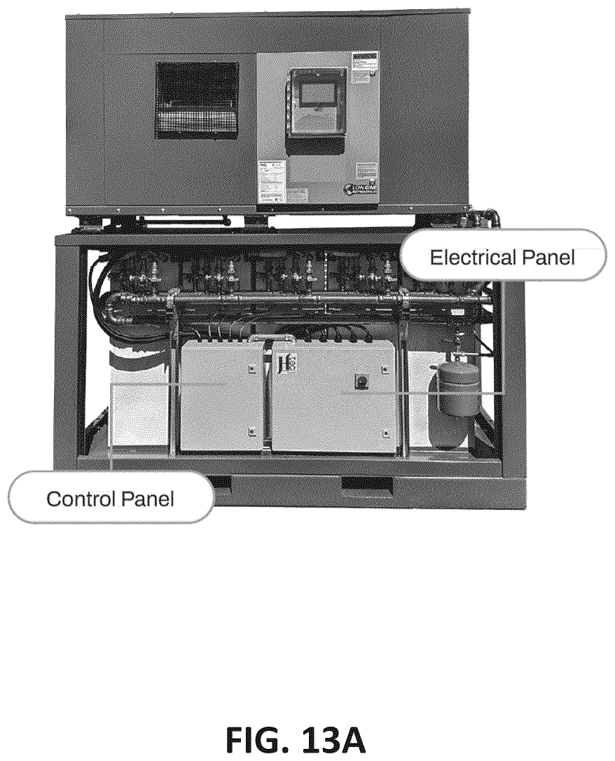

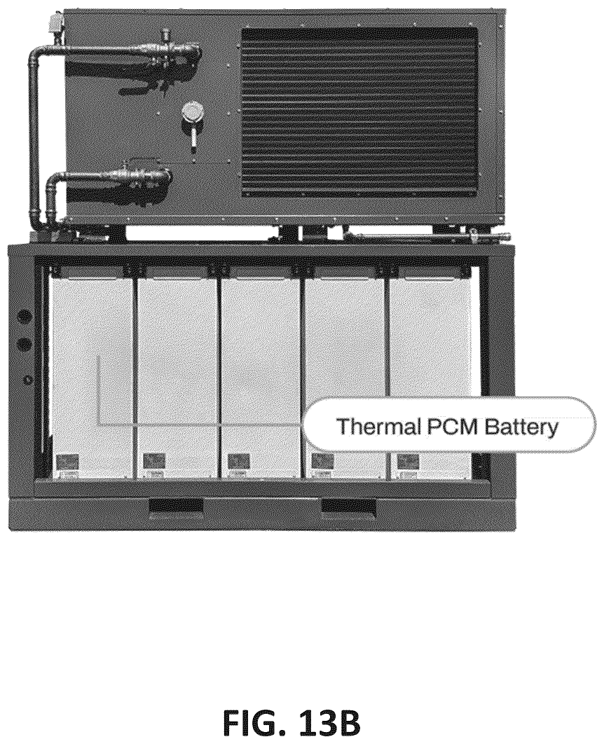

Referring now to FIG. 13A and FIG. 13B, in accordance with the various aspects and embodiments of the invention, a system 1310 includes space-saving mounting configuration utilizing a design, wherein the HPWH is mounted above the PCM batteries, thereby saving significant space. The stacking configuration is one example and does not limit the scope of the invention.

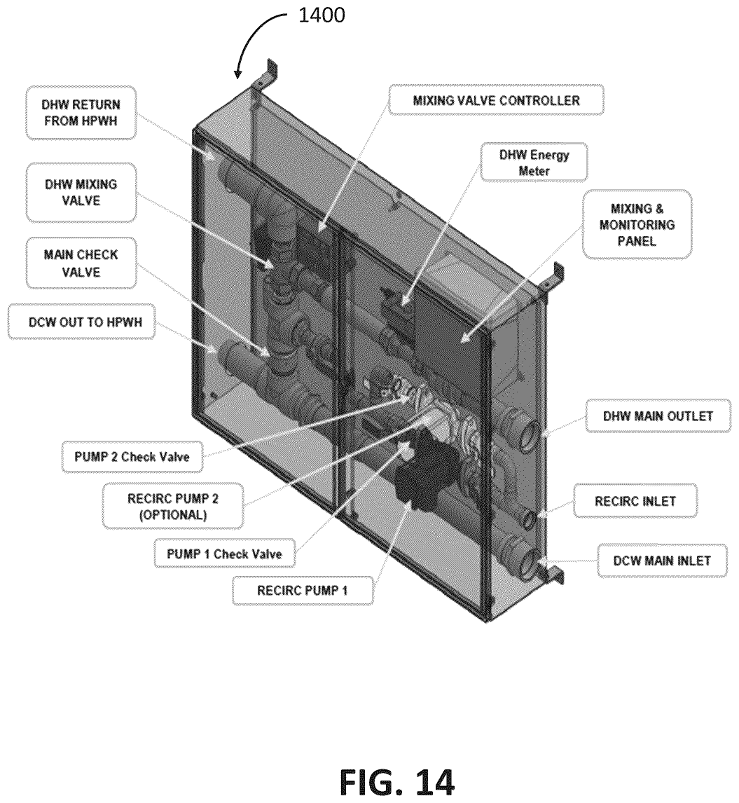

Referring now to FIG. 14 show a mixing station 1400 of the system 1000 of FIG. 10 in accordance with some aspects and embodiments of the invention. The mixing station 1400 is available for both return to primary heating tank and for the swing tank configurations. The mixing station 1400 includes energy metering and remote monitoring as capability and the related information can be fed to the AI module for training. One advantage of the mixing station 1400 is further reduction in errors and problem and complicacies experienced in the field when installing the system 1000.

In accordance with the various aspects and embodiments of the invention, the system includes dynamic load management. The system can dynamically adjust the operation of the HPWH and the EHE based on real-time grid demand, optimizing energy consumption and cost-efficiency. In accordance with the various aspects and embodiments of the invention, the system can participate in demand response programs to reduce load during peak periods in exchange for incentives.

In accordance with the various aspects and embodiments of the invention, the system includes remote monitoring and control capabilities. A user of the system can remotely monitor the status, performance, and energy consumption of the PCM batteries and HPWH via a mobile application or web interface. In accordance with the various aspects and embodiments of the invention, the system's users can remotely adjust settings and receive notifications for maintenance or fault conditions.

In accordance with the various aspects and embodiments of the invention, the system allows for integration with renewable energy sources. The system can utilize solar, wind, or other renewable energy sources to charge the PCM batteries and supplement the HPWH operation. The system can optimize the use of renewable energy based on availability and cost, reducing reliance on grid electricity.

In accordance with the various aspects and embodiments of the invention, the system includes a modular and scalable design for PCM battery systems. The system can easily be expanded by adding additional PCM battery modules to increase storage capacity. The modular design allows for easy installation and maintenance, enhancing flexibility for different application sizes and requirements.

In accordance with the various aspects and embodiments of the invention, the system includes advanced insulation and heat retention technologies, wherein the PCM batteries are enclosed in high-performance insulation materials to minimize heat loss and maximize energy efficiency. The system includes heat retention mechanisms to ensure consistent water temperature during low usage periods.

In accordance with the various aspects and embodiments of the invention, the system includes smart grid compatibility, wherein the system can communicate with smart grid infrastructure to optimize energy usage and participate in grid stability initiatives and the system can automatically adjust its operation based on real-time grid conditions and pricing signals.

In accordance with the various aspects and embodiments of the invention, the system includes enhanced safety features. The system includes multiple safety mechanisms, such as pressure relief valves, temperature sensors, and automatic shut-off features to prevent overheating and ensure safe operation. The system is designed to comply with all relevant safety standards and regulations.

In accordance with the various aspects and embodiments of the invention, the system includes a user-friendly interface and control system, wherein an intuitive user interface allows for easy operation and monitoring. The control system provides detailed data and insights on system performance, energy consumption, and cost savings.

In accordance with the various aspects and embodiments of the invention, the system includes predictive maintenance and diagnostics. In accordance with the various aspects and embodiments of the invention, the system uses a machine learning model trained with algorithms to predict potential failures and maintenance needs before they occur. The system provides diagnostics and troubleshooting guidance to ensure quick and effective resolution of issues.

In accordance with the various aspects and embodiments of the invention, the system includes adaptive learning algorithms trained using feedback, thereby allowing the AI of the system to continuously learn from usage patterns and adjusts its operation to optimize performance and energy efficiency. The system can predict future water demand and adjust charging cycles accordingly.

In accordance with the various aspects and embodiments of the invention, the system includes support for hybrid operation modes, wherein the system can seamlessly switch between different heating modes (e.g., heat pump, electric resistance, renewable energy) based on availability, cost, and efficiency. Additionally, in accordance with the various aspects and embodiments of the invention, the system operates in a hybrid mode using a combination of heat pump and electric resistance to meet high demand periods.

In accordance with the various aspects and embodiments of the invention, the system includes an automated self-cleaning mechanism, wherein the self-cleaning technology prevents buildup of scale and sediment within the PCM batteries and HPWH. The system also includes an automated self-cleaning mechanism to reduce maintenance requirements and prolongs the lifespan of the system.

In accordance with the various aspects and embodiments of the invention, the system includes emergency backup power capabilities, wherein integrated battery storage provides backup power during outages, ensuring continuous operation of the HPWH and PCM batteries and the system prioritizes essential functions during power outages to conserve energy and maintain critical operations.

In accordance with the various aspects and embodiments of the invention, the system includes enhanced water quality control features. The system includes water filtration and purification mechanisms to ensure high-quality, safe, and clean water. Additionally, the system can monitor and adjust water PH levels, hardness, and other quality parameters to prevent corrosion and scale formation.

In accordance with the various aspects and embodiments of the invention, the system includes leak detection modules and automatic shutoff modules. The system also includes sensors, which are in communication with the modules or part of the modules, to detect leaks and automatically shut off the water supply to prevent damage and water loss. In accordance with the various aspects and embodiments of the invention, the system sends alerts to users and maintenance personnel in the event of a leak or failure of the shut-off mechanism.

In accordance with the various aspects and embodiments of the invention, the system includes customizable user preferences, wherein users can set personalized temperature schedules, energy-saving modes, and other preferences through a user-friendly interface. The system can provide tailored recommendations based on user habits and preferences to enhance comfort and efficiency.

Unless defined otherwise, all technical and scientific terms used herein have the same meaning as commonly understood by one of ordinary skill in the art to which this invention belongs. The verb couple, its gerundial forms, and other variants, should be understood to refer to either direct connections or operative manners of interaction between elements of the invention through one or more intermediating elements, whether or not any such intermediating element is recited. Any methods and materials similar or equivalent to those described herein can also be used in the practice of the invention. Representative illustrative methods and materials are also described.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates, which may need to be independently confirmed.

Additionally, it is intended that equivalents include both currently known equivalents and equivalents developed in the future, i.e., any elements developed that perform the same function, regardless of structure. The scope of the invention, therefore, is not intended to be limited to the exemplary embodiments shown and described herein.

In accordance with the teaching of the invention a controller may include or be part of a computer and may include a computing device. Such devices are articles of manufacture. Other examples of an article of manufacture include: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

The articles of manufacture (e.g., computer or computing device) mentioned herein may also include a non-transitory computer readable medium or storage that may include a series of instructions, such as computer readable program steps or code encoded therein or stored thereon. In certain aspects of the invention, the non-transitory computer readable medium includes one or more data repositories. Thus, in certain embodiments that are in accordance with any aspect or embodiment of the invention, computer readable program code (or code) may be encoded in a non-transitory computer readable medium of the computing device. The processor or a module, in turn, executes the computer readable program code to cause the system to perform a task. The term “module” as used herein may refer to one or more circuits, components, registers, processors, software subroutines, or any combination thereof. In other aspects of the embodiments, the creation or amendment of the computer-aided design is implemented as a web-based software application in which portions of the data related to the computer-aided design or the tool or the computer readable program code are received or transmitted to a computing device of a host.

An article of manufacture or system, in accordance with various aspects of the invention, may be implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

Accordingly, the preceding merely illustrates the various aspects and principles as incorporated in various embodiments of the invention. It will be appreciated that those of ordinary skill in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

Therefore, the scope of the invention, is not intended to be limited to the various aspects and embodiments discussed and described herein. Rather, the scope and spirit of invention is embodied by the appended claims.

What is claimed is:

1. A system for centralized control of electric elements used for heat exchange in a phase change material (PCM) battery, wherein the system includes a controller, wherein the controller does at least one or more of:
activates a plurality of electric elements when a heat pump water heater (HPWH) operates during times of peak demand;
activates the plurality of electric elements when weather conditions do not permit operation of the HPWH, particularly in low outside air temperatures;
activates the plurality of electric elements when the HPWH is in defrost mode;
activates the plurality of electric elements when the HPWH is not operational due to an internal fault;
activates the plurality of electric elements when the HPWH has charged the PCM batteries to its full ability to maximize temperature of the PCM batteries beyond capability of the HPWH;
activates the plurality of electric elements based on demand response commands from utility companies;
activates the plurality of electric elements based on internal analytics of historical trending data;
activates the plurality of electric elements based on machine learning; and
activates the plurality of electric elements with overheat protection code to prevent damaging the PCM batteries based on internal temperature of the PCM batteries.

2. A system comprising:
a controller having input and output channels for communication with at least one or more of wireless networks and wired networks;
a plurality of phase change material (PCM) batteries, wherein the controller is in communication with the PCM batteries and wherein the PCM batteries each include at least one sensor;
at least one heat pump water heater (HPWH) connected to the plurality of PCM batteries, wherein the HPWH is in communication with the controller; and
a plurality of electrical elements connected to the plurality of PCM batteries, wherein the electrical elements are activated by the controller,
wherein the controller receives information from the HPWH and sensor information from the sensor of the PCM batteries and the controller activates the electrical elements to heat the PCM batteries when the sensor information from the PCM batteries indicate that the PCM batteries will need require further heating due to demands on the system.

3. The system of claim 2, wherein the controller includes a machine learning model, wherein the machine learning model uses the sensor information and external information to provide control information to the controller.

4. The system of claim 2, wherein a machine learning model receives training and feedback information from at least one or more of: the PCM batteries, the HPWH, environmental conditions, power utility companies, and a building system controller of a building connected to the system.
